(19) United States
(12) Patent Application Publication
(10) Pub. No.: US 2025/0250056 A1
(43) Pub. Date: Aug. 7, 2025

(54) BOX-SHAPED BODY

(71) Applicant: YAZAKI CORPORATION, Tokyo (JP)

(72) Inventors: Ayumu Kurizono, Makinohara-shi (JP); Tsukasa Saito, Makinohara-shi (JP); Etsurou Takai, Makinohara-shi (JP); Toshihisa Yagi, Tokyo (JP); Yuta Masuda, Tokyo (JP)

(21) Appl. No.: 19/031,162

(22) Filed: Jan. 17, 2025

(30) Foreign Application Priority Data
Feb. 5, 2024 (JP) 2024-015500

(51) Int. Cl. B65D 1/40; B60R 16/03; B65D 1/22; B65D 43/02

(52) U.S. Cl. CPC B65D 1/40; B65D 1/22; B65D 43/0212; B60R 16/03; B65D 2543/00212; B65D 2543/00537; B65D 2543/00574; B65D 2543/00648; B65D 2543/00694; B65D 2543/00759; B65D 2543/00805

(57) ABSTRACT

A box-shaped body includes: a case having a tubular peripheral wall; and a cover. The cover includes an engaging portion extending in an attachment direction in which the cover is attached to the case. The peripheral wall has a multilayer wall structure including an inner wall and an outer wall, and includes a connecting wall and an engaged portion, and the engaged portion being configured to be engaged with the engaging portion. An end surface of the connecting wall facing the cover is located at a position, closer to the cover in the attachment direction than an end surface of at least one of the inner wall and the outer wall facing the cover, or the same position, in the attachment direction as the end surface of at least one of the inner wall and the outer wall facing the cover.

### CROSS-REFERENCE TO RELATED APPLICATION(S)

This application is based upon and claims the benefit of priority from prior Japanese patent application No. 2024-015500 filed on Feb. 5, 2024, the entire contents of which are incorporated herein by reference.

### BACKGROUND

### 1. Field of the Invention

The present disclosure relates to a box-shaped body including a case that has a peripheral wall surrounding an internal space, and a cover that is assembled to an opening end of the case.

### 2. Description of the Related Art

In the related art, a box-shaped body configured by assembling a plurality of members to each other, such as an electric junction box (for example, a relay box) mounted on a vehicle, has been proposed. For example, an electric junction box in the related art includes a body case that holds an electronic component and the like, and a cover that is assembled to the body case. In this electric junction box, the cover is assembled to be fitted to a wall end of a peripheral wall of the body case (for example, see JP2020-182314A).

In the electric junction box in the related art described above, the peripheral wall of the case has a double wall structure having an inner wall and an outer wall from a viewpoint of improving waterproofness and the like. By assembling the cover to the case, an opening between layers of the inner wall and the outer wall is closed by the cover. However, since a gap between such layers is present in the peripheral wall of the case, an engaging portion (for example, a lock claw having a cantilever shape) provided on the cover may erroneously enter the gap between the layers when the cover is assembled to the case, and the cover may not be properly assembled to the case. From a viewpoint of improving operability of an operation of assembling the cover and the case, it is desirable to prevent the engaging portion from entering the gap between the layers as much as possible. As understood from the above description, it is desirable to improve operability of an assembly operation in a box-shaped body including a cover and a case, not limited to the electric junction box.

### SUMMARY

An object of the present disclosure is to provide a box-shaped body capable of improving operability of an assembly operation.

In order to achieve the above object, a box-shaped body according to the present disclosure is characterized as follows.

According to an aspect of the present disclosure, there is provided a box-shaped body including: a case having a tubular peripheral wall; and a cover configured to be attached to the peripheral wall to cover an opening end of the case, in which: the cover includes an engaging portion extending in an attachment direction in which the cover is attached to the case; the peripheral wall of the case has a multilayer wall structure including an inner wall and an outer wall, and includes a connecting wall and an engaged portion, the connecting wall being configured to connect the layers of the inner wall and the outer wall, and the engaged portion being configured to be engaged with the engaging portion; the engaged portion is disposed such that the outer wall is sandwiched between the connecting wall and the engaged portion; and the connecting wall has a shape extending from a space between the layers such that an end surface of the connecting wall facing the cover is located at a position closer to the cover in the attachment direction than an end surface of at least one of the inner wall and the outer wall facing the cover, or a shape accommodated between the space between the layers such that the end surface of the connecting wall facing the cover is located at the same position in the attachment direction as the end surface of at least one of the inner wall and the outer wall facing the cover.

According to the box-shaped body according to the present disclosure, a connecting wall and an engaged portion are disposed to be adjacent to each other with an outer wall sandwiched therebetween. The connecting wall connects layers of an inner wall and the outer wall of a case. The engaged portion is engaged with an engaging portion of a cover. Therefore, when the engaging portion of the cover approaches the engaged portion of the case at the time of assembling the case and the cover, the engaging portion is prevented from entering a space between the layers of the inner wall and the outer wall of the case by an action of the connecting wall even when the engaging portion erroneously approaches the space between the layers. Accordingly, it is not necessary for an operator to visually check whether the engaging portion enters the space between the layers. Therefore, the box-shaped body according to the present configuration can improve operability of an assembly operation.

Further, as another effect, the connecting wall can prevent occurrence of a molding defect in which the space between the layers of the inner wall and the outer wall becomes narrower or wider than a design value when the case is molded using a resin. As a result, the engagement between the engaging portion and the engaged portion is prevented from being hindered due to the molding defect.

The present disclosure is briefly described above. Details of the present disclosure can be clarified by reading a mode for carrying out the invention to be described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view showing a box-shaped body according to an embodiment of the present disclosure;

FIG. 2 is a perspective view showing a state in which an upper cover is being assembled to a body case and a lower cover is separated from the body case in the box-shaped body shown in FIG. 1;

FIG. 3 is a perspective view showing a state in which assembly of the box-shaped body shown in FIG. 1 is completed;

FIG. 4 is an enlarged view of a portion A in FIG. 1;

FIG. 5 is a top view of the portion A in FIG. 1;

FIG. 6 is a cross-sectional view taken along a line B-B in FIG. 5;

FIG. 7 is a perspective view of the upper cover shown in FIG. 1 as viewed from below.

FIG. 8 is an enlarged view of a portion C in FIG. 7;

FIG. 9 is an enlarged view showing a periphery of an engaged portion shown in the portion A in FIG. 1 when the upper cover is being assembled to the body case;

FIG. 10 is a cross-sectional view taken along a line D-D in FIG. 9;

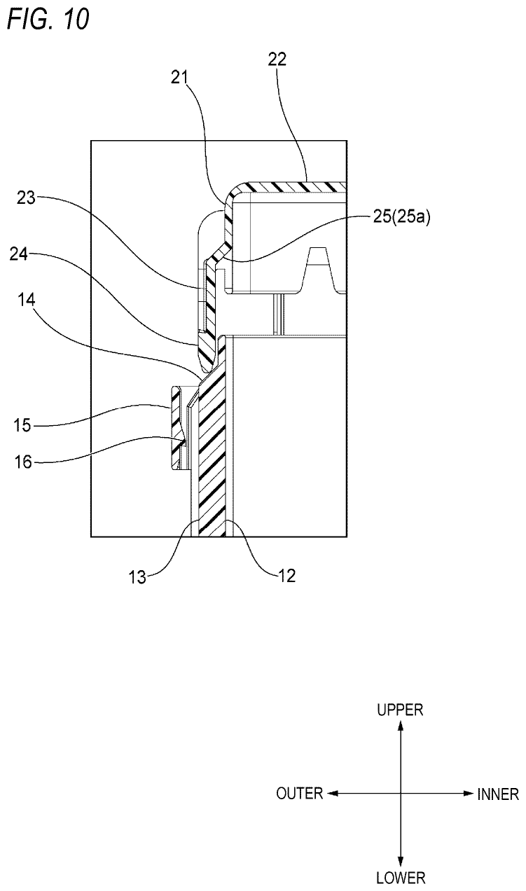

FIG. 11 is a view corresponding to FIG. 10 in a state in which the assembly of the upper cover to the body case is completed;

FIG. 12 is an enlarged view showing a periphery of the engaged portion having an auxiliary wall when the upper cover is being assembled to the body case; and

FIG. 13 is a cross-sectional view taken along a line E-E in FIG. 12.

### DETAILED DESCRIPTION OF THE INVENTION

### Embodiment

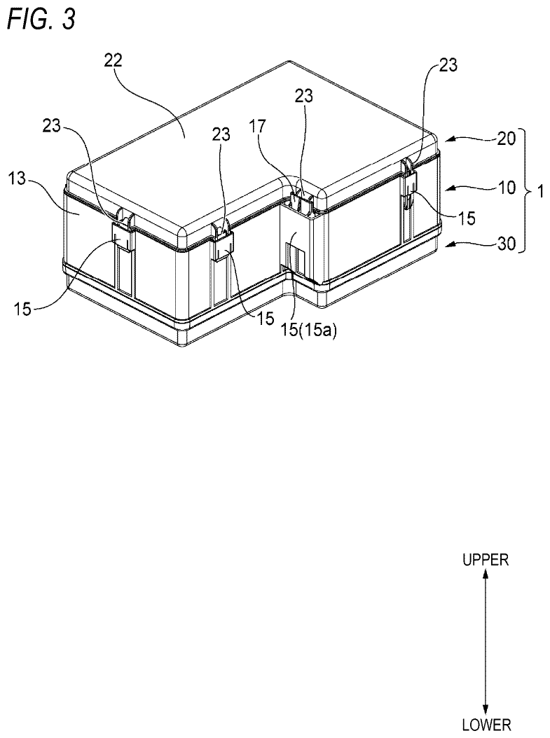

Hereinafter, a box-shaped body 1 according to an embodiment of the present disclosure shown in FIG. 3 will be described with reference to the drawings. The box-shaped body 1 is typically a relay box (electric junction box) that is attached to a frame or the like of a vehicle and accommodates an electronic component such as a relay.

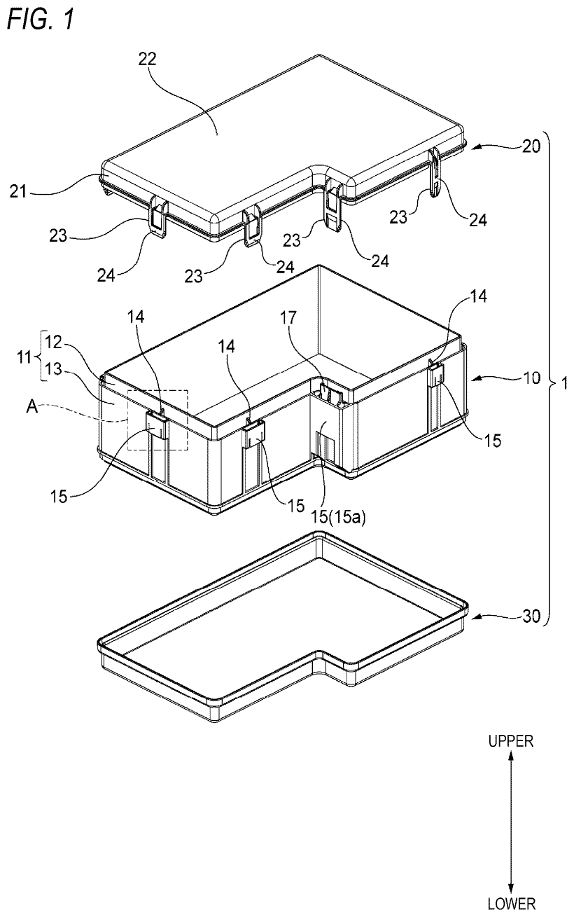

As shown in FIG. 1, the box-shaped body 1 is a box-shaped body including a body case 10, an upper cover 20, and a lower cover 30. The body case 10 accommodates an electronic component such as a relay (and another component that is not shown). The upper cover 20 is assembled to an upper end of the body case 10 to close an upper end opening (opening end) of the body case 10. The lower cover 30 is assembled to a lower end of the body case 10 to close a lower end opening (opening end) of the body case 10. Each of the body case 10, the upper cover 20, and the lower cover 30 is a resin molded body. The body case 10 corresponds to a “case” in the present disclosure. The upper cover 20 corresponds to a “cover” in the present disclosure.

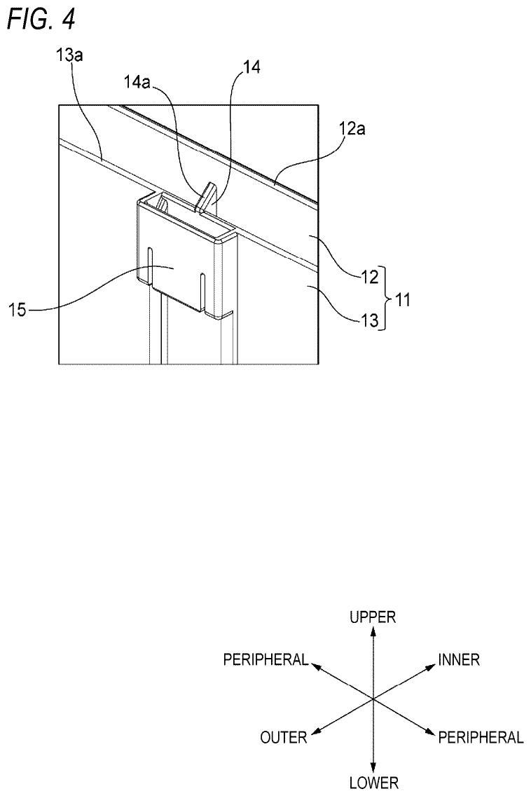

Hereinafter, for convenience of description, a direction of the box-shaped body 1 in a vehicle-mounted posture, which corresponds to an upper-lower direction of a vehicle, is defined as an “upper-lower direction”. A peripheral direction of a peripheral wall 11 of the body case 10 described later is defined as a “peripheral direction”. A thickness direction of the peripheral wall 11 is defined as an “inner-outer direction”. The “upper-lower direction”, the “peripheral direction”, and the “inner-outer direction” are orthogonal to each other (see FIGS. 4,8, and 9). “Inner” and “outer” of the “inner-outer direction” respectively correspond to inside and outside of the box-shaped body 1 that is a box-shaped body. The “upper-lower direction” is merely defined for convenience of description, and does not necessarily correspond to the upper-lower direction of the vehicle or the like when the box-shaped body 1 is mounted on the vehicle or the like. For example, the box-shaped body 1 may be used in a posture in which the upper cover 20 is located on an upper side or in a posture in which the upper cover 20 is located on a lower side. Hereinafter, the body case 10 and the upper cover 20 constituting the box-shaped body 1 will be described in detail.

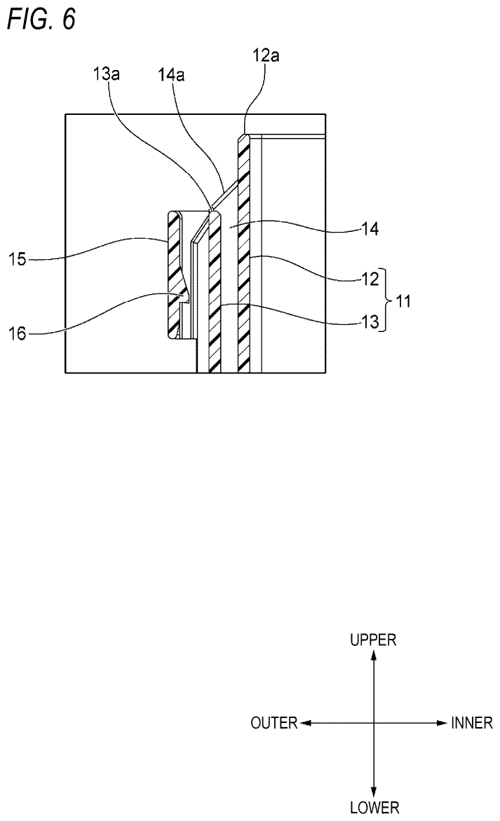

First, the body case 10 will be described. As shown in FIG. 1, the body case 10 includes the tubular peripheral wall 11 that has a substantially L shape when viewed in the upper-lower direction and that extends in the upper-lower direction. A plurality of accommodating portions (not shown) accommodating electronic components (and other components) such as a relay are provided in an internal space of the body case 10 defined by the peripheral wall 11. The peripheral wall 11 has a so-called two-layer wall structure including an inner wall 12 and an outer wall 13 over the entire peripheral direction. The outer wall 13 is located outside the inner wall 12 and is spaced apart from the inner wall 12. As shown in FIGS. 4 and 6, in this example, an upper end surface 13a of the outer wall 13 is located lower than an upper end surface 12a of the inner wall 12.

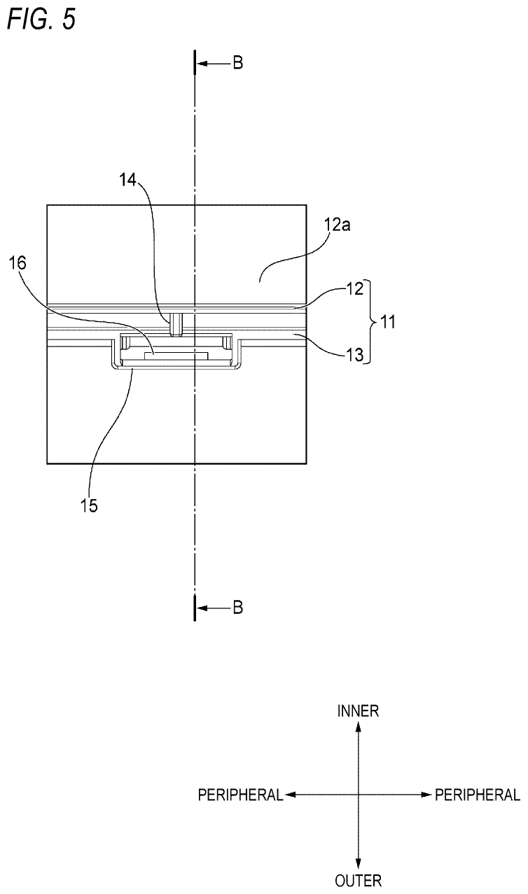

As shown in FIG. 1, an outer surface of an upper end edge of the outer wall 13 that constitutes the peripheral wall 11 is provided with engaged portions 15 at a plurality of positions (eight positions in this example) in the peripheral direction. In a state in which assembly of the body case 10 and the upper cover 20 is completed (see FIG. 3), the plurality of engaged portions 15 are respectively engaged with a plurality of engaging portions 23 that is provided on the 10 upper cover 20 and that is described later. In this example, as shown in FIG. 4 and the like, each of the engaged portions 15 is a substantially rectangular tubular portion which is wide in the peripheral direction and in which a locking hole penetrating in the upper-lower direction is defined. A projection 16 projecting toward inside of the locking hole (that is, toward the inside) is provided at a substantially center position in the upper-lower direction of an outer one of inner wall surfaces that define the locking hole in the engaged portion 15 (see FIGS. 5 and 6). An upper end surface of the engaged portion 15 (that is, an upper opening edge of the locking hole) and the upper end surface 13a of the outer wall 13 are located at the same position in the upper-lower direction (see FIG. 4).

As shown in FIG. 1, the peripheral wall 11 is provided with connecting walls 14 at positions in the peripheral direction where the plurality of engaged portions 15 are provided, respectively (see also FIG. 4). The connecting wall 14 connects the layers of the inner wall 12 and the outer wall 13 in the inner-outer direction and extends in the upper-lower direction. That is, the engaged portion 15 is disposed such that the outer wall 13 is sandwiched between the connecting wall 14 and the engaged portion 15. In other words, each connecting wall 14 is provided to be adjacent to an inner side of corresponding one of the engaged portions 15. In this example, an upper end surface 14a of the connecting wall 14 is inclined downward (that is, to approach the engaged portion 15 in the upper-lower direction) from the inner wall 12 toward the outer wall 13. As shown in FIGS. 4 and 6, an outer end of the upper end surface 14a of the connecting wall 14 (a portion connected to the outer wall 13) and the upper end surface 13a of the outer wall 13 are located at the same position in the upper-lower direction, and an inner end of the upper end surface 14a of the connecting wall 14 (a portion connected to the inner wall 12) is located lower than the upper end surface 12a of the inner wall 12. An operation achieved by providing the connecting wall 14 for the corresponding engaged portion 15 will be described later.

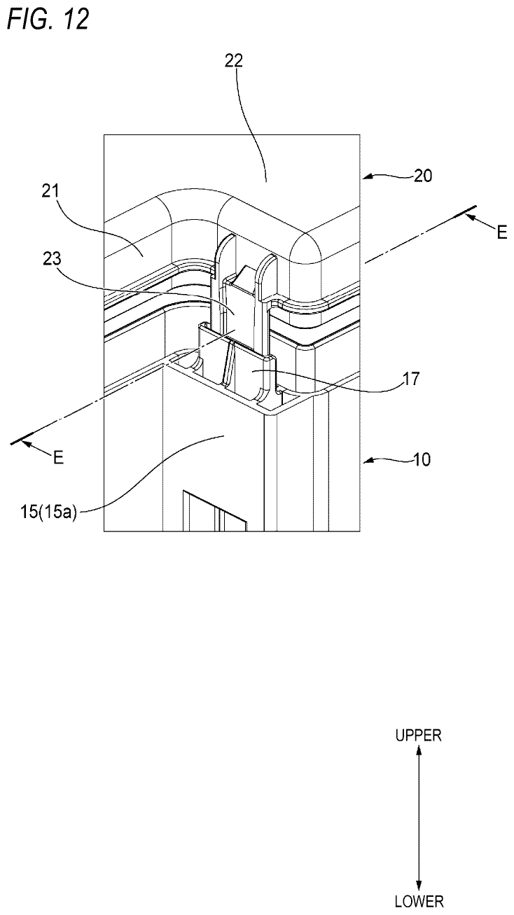

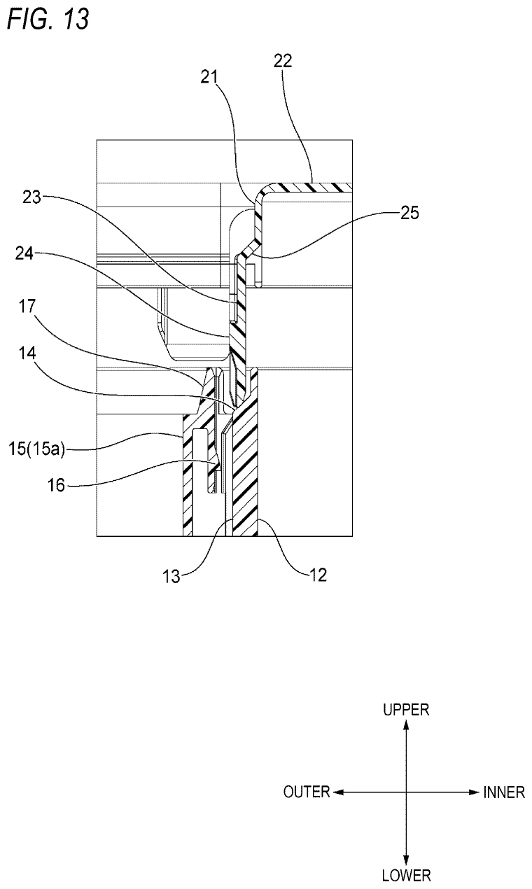

An engaged portion 15a (see FIG. 1 and the like) which is one of the plurality of engaged portions 15 is further provided with an auxiliary wall 17. As shown in FIGS. 12 and 13, the auxiliary wall 17 is a substantially flat plate-shaped wall that protrudes further upward from an upper portion of an outer wall defining the locking hole in the engaged portion 15a and that extends in the peripheral direction. In other words, the auxiliary wall 17 is disposed such that corresponding one of the engaging portions 23 is sandwiched between the auxiliary wall 17 and the connecting wall 14 that is adjacent to an inner side of the engaged portion 15a. An operation achieved by providing such auxiliary wall 17 will be described later.

Next, the upper cover 20 will be described. As shown in FIG. 1, the upper cover 20 integrally includes a tubular peripheral wall 21 and a flat plate-shaped top wall portion 22. The peripheral wall 21 has a substantially L shape corresponding to the peripheral wall 11 of the body case 10 when viewed in the upper-lower direction and extends in the upper-lower direction. The top wall portion 22 closes an upper end opening (opening end) of the peripheral wall 21. An outer surface of the peripheral wall 21 is provided with the engaging portions 23 at a plurality of positions (eight positions in this example) in the peripheral direction corresponding to the plurality of engaged portions 15 of the body case 10. In this example, each engaging portion 23 is a substantially elongated flat plate-shaped portion that extends downward from the outer surface of the peripheral wall 21 in a cantilever shape and that protrudes further downward from a lower end edge of the peripheral wall 21. An outer surface of the engaging portion 23 is provided with a projection 24 that is to be engaged with the projection 16 of the engaged portion 15 of the body case 10.

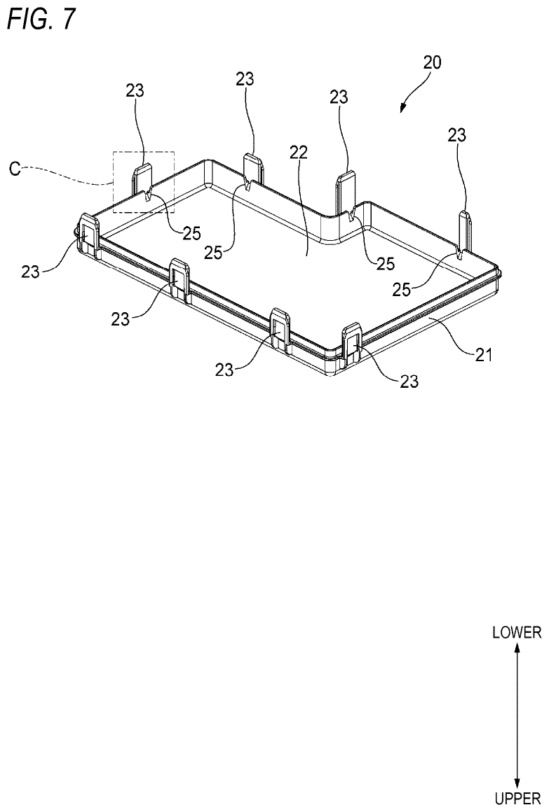

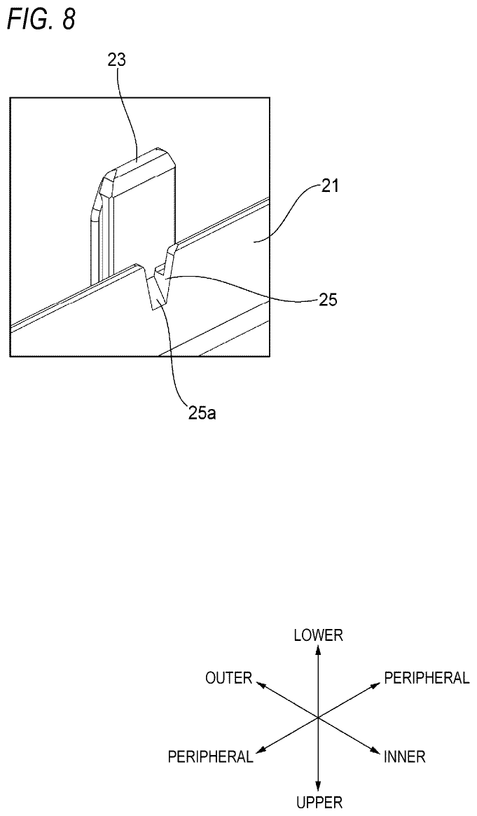

As shown in FIGS. 7 and 8, the lower end edge of the peripheral wall 21 is provided with recesses 25, which are recessed upward in a substantially V-shape, at positions in the peripheral direction where the plurality of engaging portions 23 are provided, respectively. When the upper cover 20 is assembled to the body case 10, the recess 25 functions to receive the upper end surface 14a of the corresponding connecting wall 14 of the body case 10. Therefore, in accordance with the inclination of the upper end surface 14a of the connecting wall 14, a bottom surface 25a of the recess 25 is inclined downward from the inside to the outside (see FIG. 8). Accordingly, the connecting wall 14 of the body case 10 is prevented from interfering with the peripheral wall 21 of the upper cover 20.

As shown in FIGS. 7 and 8, an outer space of the recess 25 is covered with corresponding one of the engaging portions 23. Accordingly, even when the box-shaped body 1 is exposed to water, the water is not directly directed to the recess 25 due to the engaging portion 23. As a result, a gap is present in the peripheral wall 21 by providing the recess 25 in the peripheral wall 21 of the upper cover 20, but deterioration of waterproofness of the box-shaped body 1 caused by the recess 25 is prevented.

When the box-shaped body 1 is used in a posture in which the upper cover 20 is located on the lower side, the recess 25 guides (discharges), into the inside of the box-shaped body 1 through the inclined bottom surface 25a, water accumulated around an engagement point of the engaging portion 23 and the engaged portion 15 when the box-shaped body 1 is exposed to water, thereby exhibiting an effect of preventing the water from remaining around the engagement point for a long period. The water guided into the box-shaped body 1 may be discharged to the outside of the box-shaped body 1 through a discharge port or the like (not shown).

Next, the assembly of the body case 10 and the upper cover 20 will be described. In order to assemble the body case 10 and the upper cover 20, first, as shown in FIG. 1, the body case 10 and the upper cover 20 are disposed such that the body case 10 is located below the upper cover 20. Next, the body case 10 and the upper cover 20 are brought close to each other in the upper-lower direction, and an upper end edge of the peripheral wall 11 of the body case 10 and the lower end edge of the peripheral wall 21 of the upper cover 20 are fitted to each other. This fitting proceeds such that the lower end edge of the peripheral wall 21 enters between upper end edges of the inner wall 12 and the outer wall 13 which constitute the peripheral wall 11 and the plurality of engaged portions 15 and the plurality of engaging portions 23 are respectively engaged with each other.

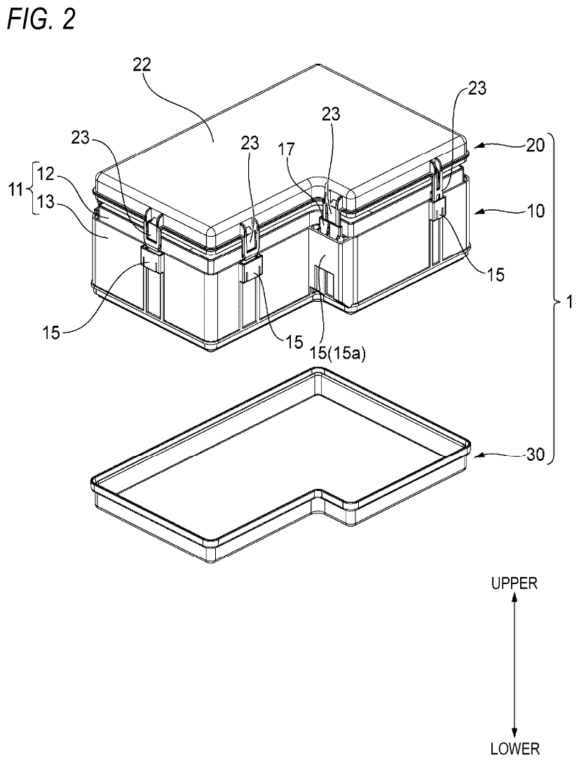

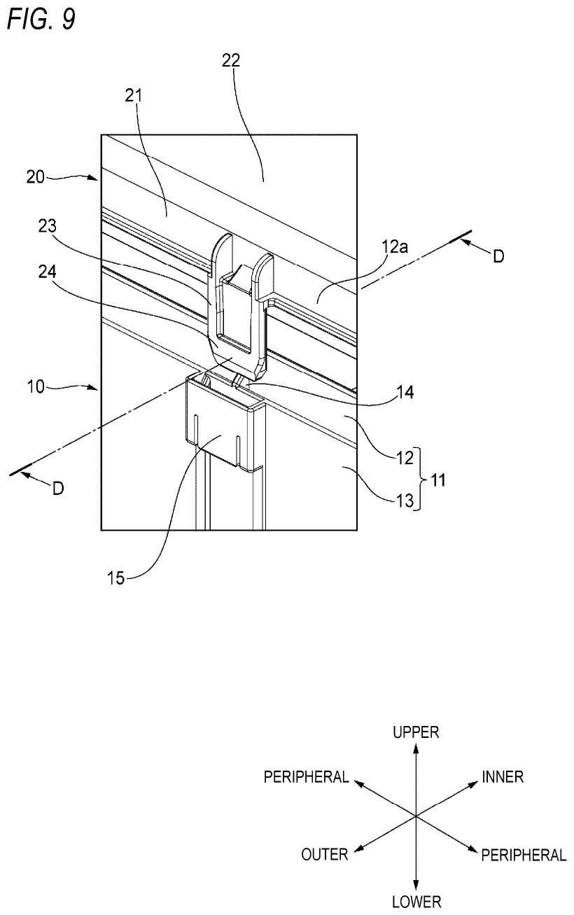

When the fitting proceeds, regarding each engaged portion 15, since the corresponding connecting wall 14 is provided to be adjacent to the inner side of the engaged portion 15 as described above, even when the engaging portion 23 of the upper cover 20 attempts to erroneously enter a space between the layers of the inner wall 12 and the outer wall 13 of the body case 10, the upper end surface 14a of the corresponding connecting wall 14 interferes with the lower end edge of the engaging portion 23 (see FIGS. 2,9, and 10), thereby preventing the engaging portion 23 from erroneously entering the space between the layers of the inner wall 12 and the outer wall 13 of the body case 10. Since the upper end surface 14a of the connecting wall 14 is inclined to approach the engaged portion 15 in the upper-lower direction from the inner wall 12 toward the outer wall 13 as described above, the upper end surface 14a of the connecting wall 14 can guide the engaging portion 23 toward the engaged portion 15 (see FIG. 9 and the like). As shown in FIGS. 12 and 13, regarding the engaged portion 15a provided with the auxiliary wall 17 among the plurality of engaged portions 15, the corresponding engaging portion 23 can be engaged with the engaged portion 15a by inserting the corresponding engaging portion 23 toward between the connecting wall 14 and the auxiliary wall 17 that is adjacent to the inner side of the engaged portion 15a.

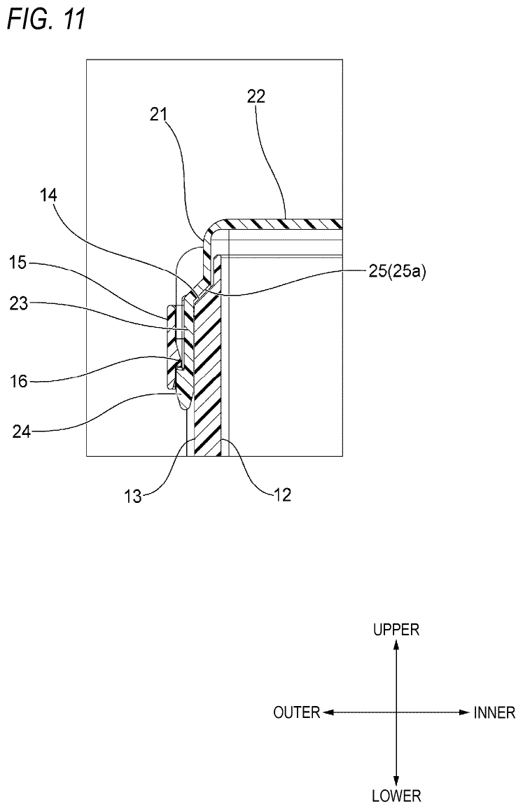

When the fitting proceeds and the projection 24 of the engaging portion 23 and the projection 16 of the engaged portion 15 are engaged with each other (see FIG. 11), the assembly of the body case 10 and the upper cover 20 is completed. In the state in which the assembly of the body case 10 and the upper cover 20 is completed (see FIG. 3), since the projection 24 of the engaging portion 23 and the projection 16 of the engaged portion 15 are engaged with each other, the body case 10 and the upper cover 20 are prevented from being separated in the upper-lower direction.

### Operation and Effect

As described above, according to the box-shaped body 1 according to the present embodiment, when the upper cover 20 is assembled to the body case 10, the engaging portion 23 of the upper cover 20 is prevented from erroneously entering the space between the layers of the inner wall 12 and the outer wall 13 of the body case 10 by the connecting wall 14 of the body case 10. Accordingly, it is not necessary for an operator to visually check whether the engaging portion 23 enters such space between the layers, and thus operability of the assembly operation can be improved.

The upper end surface 14a of the connecting wall 14 is inclined to approach the engaged portion 15 in the upper-lower direction from the inner wall 12 toward the outer wall 13. Accordingly, the upper end surface 14a of the connecting wall 14 can guide the engaging portion 23 toward the engaged portion 15. Therefore, the operability of the assembly is further improved.

When the upper cover 20 is assembled to the body case 10 by the auxiliary wall 17 provided in the engaged portion 15a of the body case 10, the engaging portion 23 can be engaged with the engaged portion 15a by inserting the engaging portion 23 toward between the connecting wall 14 and the auxiliary wall 17. Therefore, the operability of the assembly is further improved.

The upper cover 20 has the recess 25 that is recessed to receive the upper end surface 14a of the connecting wall 14 when the body case 10 and the upper cover 20 are assembled. Accordingly, the connecting wall 14 is prevented from interfering with the upper cover 20.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

For example, in the embodiment described above, since the upper end surface 14a of the connecting wall 14 is inclined, the upper end surface 14a of the connecting wall 14 is located upper than the upper end surface 13a of the outer wall 13 (located lower than the upper end surface 12a of the inner wall 12). Meanwhile, the upper end surface 14a of the connecting wall 14 may extend horizontally, and thus the upper end surface 14a of the connecting wall 14 may be located at the same position in the upper-lower direction as the upper end surface 13a of the outer wall 13 (located lower than the upper end surface 12a of the inner wall 12). In this case, the upper end surface 12a of the inner wall 12 and the upper end surface 13a of the outer wall 13 may be located at the same position in the upper-lower direction.

Here, features of the box-shaped body 1 according to the present disclosure described above are briefly summarized and listed in the following [1] to [4].
[1] A box-shaped body (1) including: the case (10) having the tubular peripheral wall (11); and the cover (20) configured to be attached to the peripheral wall (11) to cover the opening end of the case (10), in which
the cover (20) includes the engaging portion (23) extending in an attachment direction in which the cover (20) is attached to the case (10),
the peripheral wall (11) of the case (10) has a multilayer wall structure including the inner wall (12) and the outer wall (13), and includes the connecting wall (14) and the engaged portion (15), the connecting wall (14) being configured to connect the layers of the inner wall (12) and the outer wall (13), and the engaged portion (15) being configured to be engaged with the engaging portion (23),
the engaged portion (15) is disposed such that the outer wall (13) is sandwiched between the connecting wall (14) and the engaged portion (15), and
the connecting wall (14) has a shape extending from a space between the layers such that the end surface (14a) of the connecting wall (14) facing the cover (20) is located at a position closer to the cover (20) in the attachment direction than the end surface (12a, 13a) of at least one of the inner wall (12) and the outer wall (13) facing the cover (20), or a shape accommodated between the space between the layers such that the end surface (14a) of the connecting wall (14) facing the cover (20) is located at the same position in the attachment direction as the end surface (12a, 13a) of at least one of the inner wall (12) and the outer wall (13) facing the cover (20).

According to the box-shaped body having the configuration of the above [1], the connecting wall and the engaged portion are disposed to be adjacent to each other with the outer wall sandwiched therebetween. The connecting wall connects layers of the inner wall and the outer wall of the case. The engaged portion is engaged with the engaging portion of the cover. Therefore, when the engaging portion of the cover approaches the engaged portion of the case at the time of assembling the case and the cover, the engaging portion is prevented from entering the space between the layers of the inner wall and the outer wall of the case by an action of the connecting wall even when the engaging portion erroneously approaches the space between the layers. Accordingly, it is not necessary for an operator to visually check whether the engaging portion enters the space between the layers. Therefore, the box-shaped body according to the present configuration can improve the operability of the assembly operation.

Further, as another effect, the connecting wall can prevent occurrence of a molding defect in which the space between the layers of the inner wall and the outer wall becomes narrower or wider than a design value when the case is molded using a resin. As a result, the engagement between the engaging portion and the engaged portion is prevented from being hindered due to the molding defect.
[2] The box-shaped body (1) according to the above [1], in which
when the connecting wall has the shape extending from the space between the layers, the end surface (14a) of the connecting wall (14) has a shape that is inclined to approach the engaged portion (15) in the attachment direction from the inner wall (12) toward the outer wall (13).

According to the box-shaped body having the configuration of the above [2], the end surface of the connecting wall is inclined to approach the engaged portion in the attachment direction from the inner wall toward the outer wall. Accordingly, when the case and the cover are assembled, the end surface of the connecting wall can guide the engaging portion toward the engaged portion. Accordingly, the operability of the assembly is further improved.
[3] The box-shaped body (1) according to the above [1], in which
the peripheral wall (11) of the case (10) includes the auxiliary wall (17) extending toward the cover (20) in the attachment direction, the auxiliary wall (17) being located at a position closer to the cover in the attachment direction than the engaged portion, and the engaging portion passing between the auxiliary wall and the connecting wall.

According to the box-shaped body having the configuration of the above [3], when the case and the cover are assembled by the auxiliary wall of the case, the engaging portion naturally approaches the engaged portion by inserting the engaging portion toward between the auxiliary wall and the connecting wall, and thus the engaging portion can be easily engaged with the engaged portion. The engaging portion can be more easily engaged with the engaged portion by providing a structure similar to the connecting wall described above (that is, a structure having an inclined end surface) on the auxiliary wall. Accordingly, the operability of the assembly is further improved.
[4] The box-shaped body (1) according to claim 1, in which
the cover (20) has the peripheral edge (21) overlapping the peripheral wall when the case and the cover are assembled, and
the peripheral edge (21) has the recess (25) that is recessed to receive the end surface (14a) of the connecting wall (14) when the case (10) and the cover (20) are assembled.

According to the box-shaped body having the configuration of the above [4], the peripheral edge of the cover has the recess that is recessed to receive the end surface of the connecting wall when the case and the cover are assembled. Accordingly, it is possible to obtain both an effect of improving the waterproofness and the like of the box-shaped body by overlapping the peripheral edge of the cover and the peripheral wall of the case, and an effect of improving the operability by the connecting wall described above by preventing the connecting wall from interfering with the cover. For example, by disposing the engaging portion to cover the recess, even when the box-shaped body is exposed to water, the water is not directly directed to the recess due to the engaging portion. As a result, a gap is present in the peripheral wall by providing the recess, but deterioration of the waterproofness of the box-shaped body caused by the recess is prevented.

1. A box-shaped body comprising:
a case having a tubular peripheral wall; and
a cover configured to be attached to the peripheral wall to cover an opening end of the case, wherein:
the cover includes an engaging portion extending in an attachment direction in which the cover is attached to the case;
the peripheral wall of the case has a multilayer wall structure including an inner wall and an outer wall, and includes a connecting wall and an engaged portion, the connecting wall being configured to connect the layers of the inner wall and the outer wall, and the engaged portion being configured to be engaged with the engaging portion;
the engaged portion is disposed such that the outer wall is sandwiched between the connecting wall and the engaged portion; and
the connecting wall has a shape extending from a space between the layers such that an end surface of the connecting wall facing the cover is located at a position closer to the cover in the attachment direction than an end surface of at least one of the inner wall and the outer wall facing the cover, or a shape accommodated between the space between the layers such that the end surface of the connecting wall facing the cover is located at the same position in the attachment direction as the end surface of at least one of the inner wall and the outer wall facing the cover.

2. The box-shaped body according to claim 1, wherein
when the connecting wall has the shape extending from the space between the layers, the end surface of the connecting wall has a shape that is inclined to approach the engaged portion in the attachment direction from the inner wall toward the outer wall.

3. The box-shaped body according to claim 1, wherein
the peripheral wall of the case includes an auxiliary wall extending toward the cover in the attachment direction, the auxiliary wall being located at a position closer to the cover in the attachment direction than the engaged portion, and the engaging portion passing between the auxiliary wall and the connecting wall.

4. The box-shaped body according to claim 1, wherein:
the cover has a peripheral edge overlapping the peripheral wall when the case and the cover are assembled; and
the peripheral edge has a recess that is recessed to receive the end surface of the connecting wall when the case and the cover are assembled.
